(19) United States
(12) Patent Application Publication
(10) Pub. No.: US 2004/0225773 A1
(43) Pub. Date: Nov. 11, 2004

(54) Apparatus and method for transmitting arbitrary font data to an output device

(76) Inventors: Derek X. Wang, Fremont, CA (US); Stephen W. Swales, Sunnyvale, CA (US)

Correspondence Address: SUN MICROSYSTEMS INC, 4120 NETWORK CIRCLE, MS USCA12-203, SANTA CLARA, CA, 95054, US

(21) Appl. No.: 09/785,011

(22) Filed: Feb. 16, 2001

(51) Int. Cl. G06F 13/00; G06F 13/38

(52) U.S. Cl. 710/200

(57) ABSTRACT

Apparatus and methods of transmitting arbitrary font data to an output device, such as a printer, are disclosed. The method comprises determining whether rendering information for the font data to be transmitted is resident on the output device. If the rendering information for the font data to be transmitted is not resident on the output device, rendering information for the arbitrary font data is transmitted directly to the output device.

### BACKGROUND OF THE INVENTION

1. Field of the Invention

The present invention relates generally to an apparatus and method of transmitting arbitrary font data for display on an output device.

2. Description of Related Art

In traditional typography, a font is a collection of symbols, all of which belong to the same typeface and have the same point size, weight, and slant. Many of the fonts distributed for use within commonly used operating systems and printers do fit this description as well, as that is what is intuitive for most human users. However, a font may also be regarded as a collection of bitmaps. Each of the individual symbols a font comprises is called a glyph. A glyph can be the symbol for a letter of the alphabet, a number, or a punctuation mark, or it may be an entirely different kind of symbol, such as a cursor image. An encoding scheme defines a mapping between character codes stored in files or coming from other input devices, and the glyphs that should be displayed to represent those codes. For example, one commonly used encoding scheme, ASCII, defines the value 65 as the letter “A”. Each font maintains the mapping between character codes and glyphs with a data structure, such as an encoding vector, which may be expressed as a one- or two-dimensional array of glyph bitmaps. The array element indices match the character codes of the encoding scheme. Therefore, by reading the array element with the index of the character code to be mapped, one can find the glyph within the font that belongs to the character code. A font and the glyphs it comprises may also have metrics associated with them. Metrics define the dimensions of the font and of each glyph and how individual glyphs must be placed when the font is used for drawing strings of characters.

Current and previous versions of drivers for displaying images on an output device are often limited in the types of image and text data they can display. One problem is that some printer drivers only support printer resident fonts. This may result in the condition where some fonts that may be displayed on the screen cannot be printed on the printer as displayed, because the font as displayed on the screen is not a printer resident font. In output devices that have no resident fonts or only a limited number of resident fonts, this results in displayed output that may not necessarily track the displayed output defined and expected by the user.

For example, one method used in the prior art for displaying text character data on an output device is illustrated in FIG. 2. In procedure 210, it is first determined whether the specified font is resident on the output device. If the specified font is resident on the output device, in procedure 220 the text string is sent to the printer with the along with the name of the specified resident font. However, if the specified font is not resident on the output device, in procedure 230, the user-specified characters are sent to the printer and are then displayed using a default resident font set defined within the printer. In many common printers, the default resident font set is specified to be the “Times Roman” font set. Thus, the prior art methods often result in output displayed on the printer or other output device that does not reflect the way the user specified the display or the way the display appears to the user on the screen. In other words, in the prior art, what the user sees is not necessarily what the user gets.

Second, many previous versions of drivers do not support printing of fonts where a font character identifier is expressed in more than one byte. Such fonts are known in the art as multibyte fonts. Multibyte fonts are used to display characters for languages containing more than 256 characters, which is the maximum number of glyphs possible in a single byte font. Multibyte fonts are therefore used to display Asian language characters and other ideographic language characters such as Chinese, Japanese, and Korean, which may actually comprise thousands of characters. For example, there are over 65,000 characters in the Chinese language, of which approximately 8000 characters are considered commonly used. Obviously, these commonly used languages may not be expressed in any character set wherein the number of character identifiers is limited to 256 identifiers, each of which may be expressed in only a single byte of data.

Furthermore, extremely large amounts of memory within the output device may be required to store the entire font set of Chinese language characters, for example. Even storing a partial font set of commonly used characters could result in a font set containing several thousand characters being stored in the output device. Where an output device was not specifically configured to store and use these large font sets (or other non-printer resident fonts), additional processing was required to display documents utilizing these fonts on the output device. This additional processing could include converting each page of the document containing multibyte and other non printer resident fonts into a large image covering the entire page before sending it to the printer, which then prints the page as one image. This results in inefficiencies due to the additional image processing step. Additional inefficiencies in the prior art methods, such as the resulting failure to utilize the printer resident fonts, font caching routines, or other features of the output device driver may further erode processing time for documents containing multibyte or non-printer resident fonts.

Thus, a method of transmitting specified characters in specified fonts to an output device, wherein the characters may be expressed using multiple byte character identifiers, is therefore needed.

Thus, a method of transmitting arbitrary font data to any of a variety of output devices and output device configurations is needed.

### SUMMARY OF THE INVENTION

Apparatus and methods for transmitting arbitrary font data for display on an output device are disclosed. The method comprises determining whether rendering information for the font data to be transmitted is resident on the output device. If the rendering information for the font data to be transmitted is not resident on the output device, the method further comprises transmitting directly to the output device rendering information for the arbitrary font data to be transmitted. If rendering information for the font data to be transmitted is resident on the output device, rendering information for the arbitrary font data is not transmitted to the output device. In one embodiment of the present invention, the output device comprises a printer, although other output devices such as CRT or liquid crystal monitor displays, or displays for personal electronic devices such as a PDA may also be used.

In another embodiment, the rendering information for the font data to be transmitted comprises glyph information and bitmap data associated with an image. In yet another embodiment, the rendering information for the font data to be transmitted further comprises position data specifying a location for rendering the image. In an embodiment, the font data to be transmitted further comprises a character identifier associated with a character image. The character identifier further comprises either a single byte identifier including one data byte or a multiple byte identifier including two or more data bytes.

A still further implementation of the present invention provides a computer program product comprising computer program code for implementing a method for transmitting arbitrary font data to an output device. In one embodiment, the method comprises first determining whether rendering information for the font data to be transmitted is resident on the output device. If the rendering information for the font data to be transmitted is not resident on the output device, the method also comprises transmitting to the output device rendering information for the font data to be transmitted. However, if rendering information for the font data to be transmitted is resident on the output device, rendering information for the arbitrary font data is not transmitted to the output device.

According to one embodiment of the invention, the program code may be embodied in any form of a computer program product. A computer program product includes a medium which stores or transports computer readable code, or in which computer readable code may be embedded. Some examples of computer program products are: CD-ROM discs; ROM cards; floppy discs; magnetic tapes; computer hard drives; servers on a network; and signals transmitted over a network representing a computer readable program code.

A still further implementation of the present invention provides an apparatus comprising a processor, and a memory coupled to said processor. The memory stores computer code implementing a method of transmitting arbitrary font data to an output device wherein upon execution of said method on said processor, said method comprises first determining whether rendering information for the font data to be transmitted is resident on the output device. If the rendering information for the font data to be transmitted is not resident on the output device, the method of one embodiment further comprises transmitting to the output device rendering information for the font data to be transmitted. In an embodiment, the rendering information comprises glyph information and bitmap data associated with an image, and position data specifying a location for rendering the image.

One advantage of the present invention is that characters having any arbitrary font defined may be supported and displayed on an output device regardless of whether the specified font is loaded or otherwise resident on the output device.

Thus, the present invention has the further advantage of permitting an output device to display character exactly as defined by a user even if no fonts are loaded or otherwise resident on an output device.

A further advantage of the present invention is that any character from any font may be displayed, regardless of whether the identifier specifying the character to be displayed is only a single byte long or comprises multiple bytes.

A still further advantage of the present invention is that the display or printing of multiple languages, including ideographic character-based languages such as Chinese and other Asian languages, on one page, or multiple fonts on one page, may be accomplished in a straightforward manner. This adds to the versatility of user applications, such as office productivity applications or Internet applications, particularly for international users or international applications. This also facilitates the simple implementation of diagnostic programs, such as test programs to print or display all languages on a single page.

These and other features and advantages of the present invention will be more readily apparent from the detailed description set forth below taken in conjunction with the accompanying drawings.

### BRIEF DESCRIPTION OF THE DRAWINGS

FIG. 1 shows a block diagram of a computer system, which is used in connection with an embodiment of the present invention.

FIG. 2 shows a flowchart of a prior art method of transmitting font data to an output device.

FIG. 3 shows a flowchart of a method used in connection with an embodiment of the present invention.

FIG. 4 shows a diagram of the transmission of arbitrary font data in an embodiment of the present invention.

FIG. 5 shows a data structure of printer resident character rendering information used in connection with an embodiment of the present invention.

FIG. 6 shows a data structure of bitmap (non-printer resident) character rendering information used in connection with an embodiment of the present invention.

In the drawings and the following detailed description, elements with the same reference numeral are the same element. Also, the first digit of a reference numeral for an element indicates the first drawing in which that element appeared.

### DETAILED DESCRIPTION

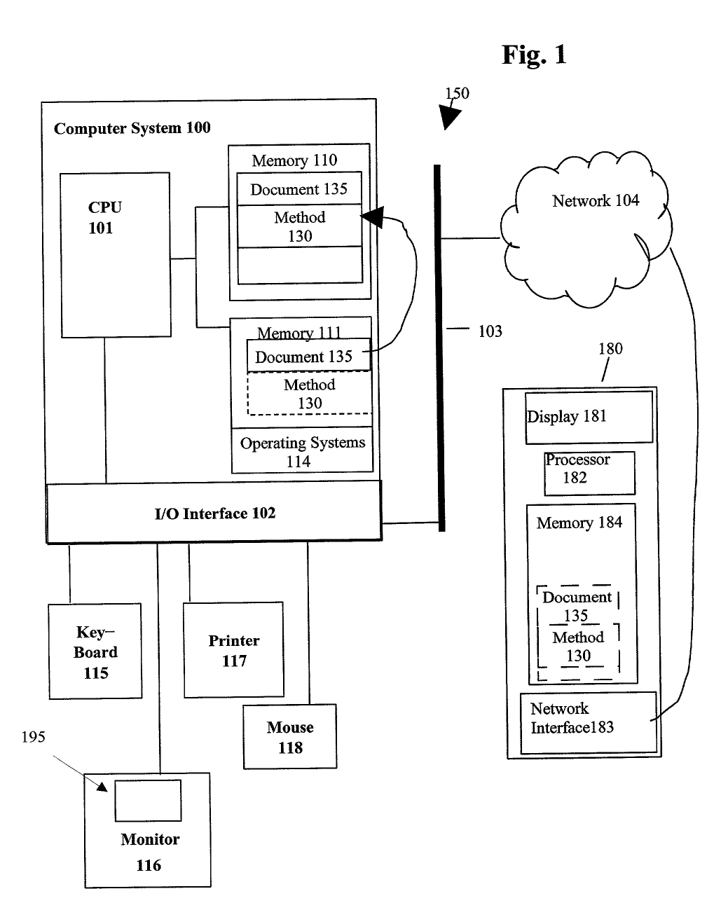

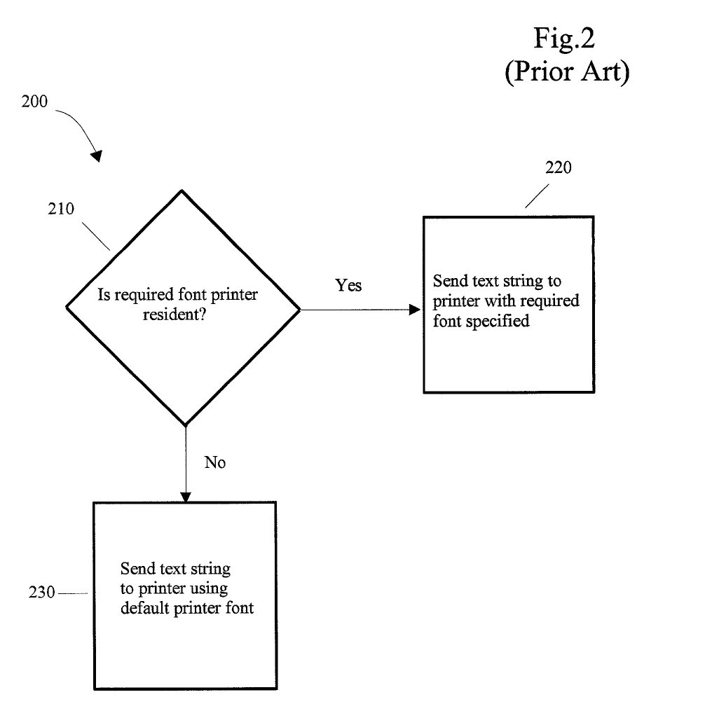

In one embodiment of the present invention shown in FIG. 1, a method 130 executing on a central processing unit (CPU) 101 of a computer system 100 transmits a document 135 including arbitrary font data to an output device such as a printer 117 or monitor 116. In addition to CPU or processor 101, computer system 100 further includes a first level memory 110 including at least a portion of computer code for implementing method 130; an operating system 114; and an input/output (I/O) interface 102. Computer system 100 may also include a second level memory 111 that may also include all or a portion of computer code directed to method 130. Like first level memory 110, second level memory 111 may comprise RAM, or a data storage device such as a hard drive. Like method 130, document 135 may also be stored in first level memory 110 or second level memory 111.

Computer system 100, in one embodiment, can be a portable computer, a workstation, a two-way pager, a cellular telephone, a digital wireless telephone, a personal digital assistant, a server computer, an Internet appliance, or any other device that includes the components shown and that can execute method 130. Similarly, in another embodiment, computer system 100 can be comprised of multiple different computers, wireless devices, cellular telephones, two-way pagers, or personal digital assistants, server computers, or any desired combination of these devices that are interconnected to perform method 130.

In one embodiment of the invention, a monitor 116 is coupled through I/O interface 102 to computer system 100. Monitor 116 is coupled to I/O interface 102 and computer system 100. Monitor 116 typically includes a display screen 195, which is typically a CRT, flat panel display or the like. Also coupled to I/O interface 102, and computer system 100, are user interfaces, such as keyboard 119 and mouse 118, as well as printer 117.

According to one embodiment of the invention, method 130 can be executed on a hardware configuration like a personal computer or workstation, as illustrated schematically in FIG. 1 by computer system 100. Method 130, however, may also be applied to a client-server configuration 150 that is also illustrated in FIG. 1. A document 135 containing font data may be stored on memory 184 of remote computer system 180. Document 135 may be transmitted to printer 117 for rendering and display of the font data, while some or all operations of method 130 are carried out on a server computer 180 accessible by a client device, such as computer system 100, over a data network 104, or networks 103 and 104, such as the Internet.

Code for executing method 130 may be stored on memory 184 of remote computer system 180 and may be executed on processor 182 of computer system 180. A user may, edit and/or view document 135 on display 181, and may initiate a request to transmit document 135 through network interface 183 and network 140 to computer system 100. Computer system 100 may in turn transmit document 135 to an output device such as printer 117 for rendering and display of font data. Computer system 180 may comprise a personal computer, portable notebook computer, PDA, cell phone, or any other device.

Herein, a computer program product comprises a medium configured to store or transport computer readable code for method 130 or in which computer readable code for method 130 is stored. Some examples of computer program products are CD-ROM discs, ROM cards, floppy discs, magnetic tapes, computer hard drives, servers on a network representing computer readable program code.

Method 130 of the present invention may be implemented in a computer program including a comprehensive SOLARIS operating system program that is available from Sun Microsystems, Inc. of Palo Alto, Calif. (SOLARIS is a trademark of Sun Microsystems.) Alternatively, method 130 may be directly implemented in any of a variety of application programs, such as office productivity application programs, that are capable of transmitting arbitrary font data to an output device. Such a computer program may be stored on any common data carrier such as, for example, a floppy disk or a compact disc (CD), as well as on any common computer system's storage facilities, such as hard disks. Therefore, one embodiment of the present invention also relates to a data carrier for storing a computer program for carrying out the inventive method. Yet another embodiment of the present invention further relates to a computer system with storage medium on which a computer program for carrying out the presented inventive method is stored.

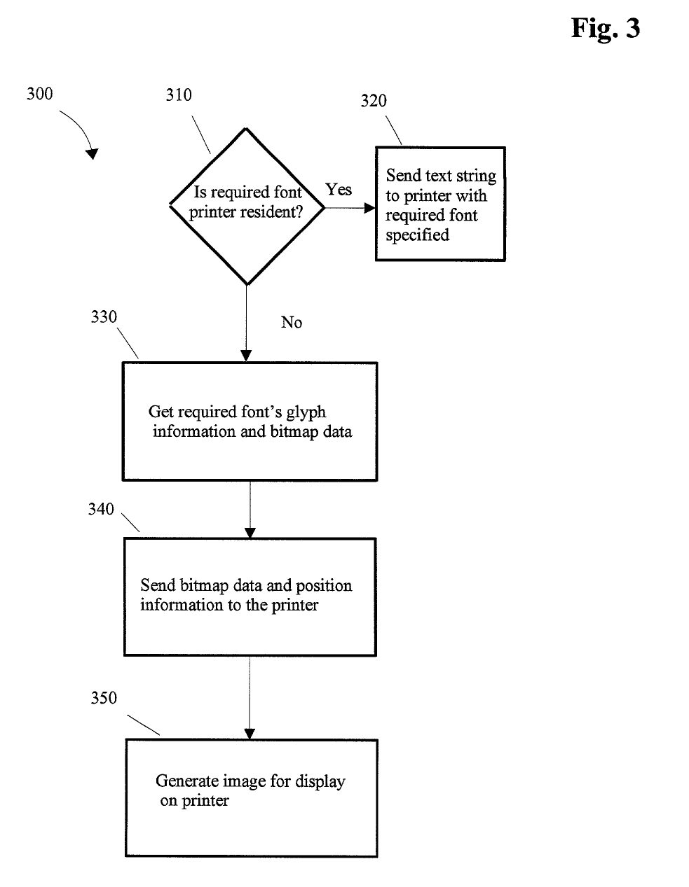

In accordance with the present invention, using method 130, any character from any arbitrary font set may be transmitted to an output device for display regardless of the characteristics of the output device used. According to an embodiment of the invention set forth in flowchart 300 of FIG. 3, if a font specified for a character is resident on the output device as determined in procedure 310, the character identifier is sent to the printer along with the identifier in procedure 320. However, if the font specified for a character is not resident on the output device, the character identifier is used to obtain the glyph information and bitmap data for the specified character within the specified font set in procedure 330. The retrieved bitmap data and glyph information, as well as position information for drawing the bitmap, is then transmitted to the printer in procedure 340. The bitmap data is used to generate an image for display on a printer in procedure 350.

The drawings and the forgoing description gave examples of the present invention. The scope of the present invention, however, is by no means limited by these specific examples. Numerous variations, whether explicitly given in the specification or not, such as differences in structure, dimension, and use of material, are possible.

For instance, the discussion above was directed, in large part, to embodiments of the invention where the output device is a printer and the arbitrary font data is used within the PostScript page description language and the Solaris operating system environment. (PostScript is a registered trademark of Adobe Systems, Inc.) However, those of skill in the art will recognize that with little or no modification, font data employed in other page description languages and other graphics and operating systems can be used with the method of the invention.

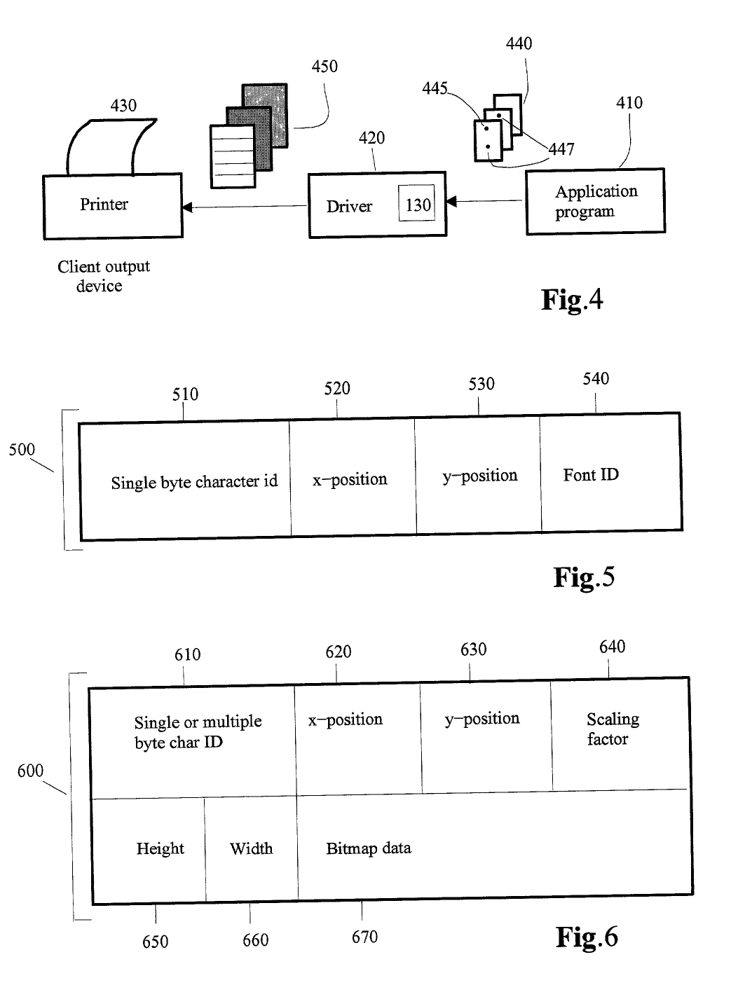

The embodiments of the invention described above may be included in any of a variety of output device driver programs known in the art, such as the Xprint printer driver, in order to support control and operation of the printer. As shown in FIG. 4, method 130 may form part of the device driver software program 420 communicating between application program 410 and the printer 430. Application program 410 may comprise an Internet web browser or the like, or an office productivity application such as a word processing, spreadsheet, email, or database application running on computer 100. The driver software program 420 receives document 135 from the application program 410. Document 135 may include one or more character encoding specifications 445, such as ASCII, and one or more font identifiers 447 within each character encoding specification. These font identifiers may in turn be associated with one or more character identifiers to specify a character defined within the specified encoding specification.

The device driver program 420 used in embodiments of the present invention converts document 135 into device readable document data 450. Within the device driver program 420, method 130 determines whether a font identifier 447 defines a printer resident font. If so, printer resident character rendering information 500 shown in FIG. 5 is generated using method 130 and sent to printer 430. This printer resident character rendering information may include character identifier 510, an x-position 520 and y-position 530 for positioning the character image on the page, and a font identifier 540. Font identifier 540 specifies the same font set as font identifier 447 in the document 135 and may be used to retrieve further rendering information for the character in the appropriate font may be retrieved.

If font identifier 447 does not identify a printer resident font, bitmap character rendering information 600 is generated in method 130 and sent to printer 430. This bitmap character rendering information may include a single or multiple byte character identifier 610, an x-position 620 and y-position 630 for positioning the character image on the page, and a scaling factor 640 to specify the dimensions of the character image on the page. A bitmap height 650 and bitmap width 660 may also be defined and included with bitmap character rendering information 600, in case dimensions of the bitmap may be needed to index the bitmap in a cache or other purpose. Bitmap data 670 is also transmitted to the printer with the bitmap character rendering information 600, and provides a bitmap version of the character image directly to the printer, thus making the rendering of the character on the printer or output device independent of the issue of whether the specified font is resident on the output device.

Those skilled in the art will readily recognize that the individual operations mentioned before in connection with the procedure of transmitting arbitrary font data to a display device according to method 130 of the present invention (and other operations and functions mentioned in connection with the foregoing description of the invention) can be performed by executing computer program instructions on CPU 101 of computer 100. The invention, however, may also be implemented by dedicated electronic circuits, which are configured such that they perform the individual operations explained before in connection with method 130 of the present invention. The invention may also be implemented by a storage medium having thereon installed computer-executable program code, which causes the CPU of a computer to perform the operations explained above according to the present invention.

The present invention is applicable to a hardware configuration like a personal computer or workstation as illustrated schematically in FIG. 1 by computer system 100. The invention, however, may also be applied to a client-server configuration that also is illustrated in FIG. 1. The images may be outputted, e.g. to printer 117 for printing, or displayed on a display screen 116 of client device 100 while some or all operations of method 130 are carried out on a server computer 180 accessible by client device 100 over a data network 104, such as the Internet, using a browser application or the like.

Herein, a computer program product comprises a medium configured to store or transport computer readable code for method 130 or in which computer readable code for method 130 is stored. Some examples of computer program products are CD-ROM discs, ROM cards, floppy discs, magnetic tapes, computer hard drives, servers on a network and signals transmitted over a network representing computer readable program code.

As illustrated in FIG. 1, this storage medium may belong to computer system 100 itself. However, the storage medium also may be removed from computer system 100. For example, method 130 may be stored in memory 184 that is physically located in a location different from processor 101. The only requirement is that processor 101 is coupled to the memory containing method 130. This could be accomplished in a client-server system 150, e.g. system 100 is the client and system 180 is the server, or alternatively via a connection to another computer via modems and analog lines, or digital interfaces and a digital carrier line.

For example, memory 184 could be in a World Wide Web portal, while display unit 116 and processor 101 are in personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 100, in one embodiment, can be a portable computer, a workstation, a two-way pager, a cellular telephone, a digital wireless telephone, a personal digital assistant, a server computer, an Internet appliance, or any other device that includes the components shown and that can execute method 130, or at least can provide the input instructions to method 130 that is executed on another system. Similarly, in another embodiment, computer system 100 can be comprised of multiple different computers, wireless devices, cellular telephones, digital telephones, two-way pagers, or personal digital assistants, server computers, or any desired combination of these devices that are interconnected to perform, method 130 as described herein.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

In view of this disclosure, method 130 can be implemented in a wide variety of computer system configurations. In addition, method 130 could be stored as different modules in memories of different devices. For example, method 130 could initially be stored in a server computer 180, and then as necessary, a module of method 130 could be transferred to a client device 100 and executed on client device 100. Consequently, part of method 130 would be executed on the server processor 182, and another part of method 130 would be executed on processor 101 of client device 100. In view of this disclosure, those of skill in the art can implement the invention of a wide-variety of physical hardware configurations using an operating system and computer programming language of interest to the user. For example, FIG. 1 shows input devices 116 and 118, but other input devices, such as speech recognition software and/or hardware could be used to input a user request to initiate execution of method 130.

In yet another embodiment, method 130 is stored in memory 184 of system 180. Stored method 130 is transferred, over network 104 to memory 111 in system 100. In this embodiment, network interface 184 and I/O interface 102 would include analog modems, digital modems, or a network interface card. If modems are used, network 104 includes a communications network, and method 130 is downloaded via the communications network.

As discussed above, method 130 of the present invention may be implemented in a computer program such as a comprehensive computer operating system, or on particular application software such as a word processing program or other office productivity application programs. Such a computer program may be stored on any common data carrier like, for example, a floppy disk or a compact disc (CD), as well as on any common computer system's storage facilities like hard disks. Therefore, the present invention also relates to a data carrier for storing a computer program for carrying out the inventive method. The present invention also relates to a method for using a computer system for carrying out the presented inventive method. The present invention further relates to a computer system with a storage medium on which a computer program for carrying out the presented inventive method is stored.

While the present invention hereinbefore has been explained in connection with one embodiment thereof, those skilled in the art will readily recognize that modifications can be made to this embodiment without departing from the spirit and scope of the present invention.

What is claimed is:

1. A method for transmitting arbitrary font data to an output device, said method comprising:
determining whether rendering information for the font data to be transmitted is resident on the output device; and
if the rendering information for the font data to be transmitted is not resident on the output device, transmitting to the output device rendering information for the font data to be transmitted.

2. The method of claim 1, wherein:
the output device comprises a printer.

3. The method of claim 1, wherein:
the rendering information for the font data to be transmitted comprises glyph information and bitmap data associated with an image.

4. The method of claim 3, wherein:
the rendering information for the font data to be transmitted further comprises position data specifying a location for rendering the image.

5. The method of claim 1, wherein:
the font data to be transmitted comprises a character identifier associated with a character image.

6. The method of claim 4 wherein:
the character identifier comprises either a single byte identifier including one data byte or a multiple byte identifier including two or more data bytes.

7. The method of claim 3 wherein:
the character image comprises an ideographic character.

8. A computer program product comprising computer program code for a method for transmitting arbitrary font data to an output device, said method comprising:
determining whether rendering information for the font data to be transmitted is resident on the output device; and
if the rendering information for the font data to be transmitted is not resident on the output device, transmitting to the output device rendering information for the font data to be transmitted.

9. The computer program product of claim 8, wherein:
the output device comprises a printer.

10. The computer program product of claim 8, wherein:
the rendering information for the font data to be transmitted comprises glyph information and bitmap data associated with an image.

11. The computer program product of claim 10, wherein said method further comprises:
the rendering information for the font data to be transmitted further comprises position data specifying a location for rendering the image.

12. The computer program product of claim 8, wherein:
the font data to be transmitted further comprises a character identifier associated with a character image.

13. The computer program product of claim 12, wherein:
the character identifier comprises either a single byte identifier including one data byte or a multiple byte identifier including two or more data bytes.

14. The computer program product of claim 10, wherein:
the character image comprises an ideographic character.

15. An apparatus comprising:
a processor; and
a memory coupled to said processor, and storing computer code implementing a method of transmitting arbitrary font data to an output device wherein upon execution of said method on said processor, said method comprises:
determining whether rendering information for the font data to be transmitted is resident on the output device; and
if the rendering information for the font data to be transmitted is not resident on the output device, transmitting to the output device rendering information for the font data to be transmitted, wherein the rendering information comprises glyph information and bitmap data associated with an image.

16. The apparatus of claim 15, wherein:
the rendering information further comprises position data specifying a location for rendering the image.

17. The apparatus of claim 15, wherein:
the output device comprises a printer.

18. The apparatus of claim 15, wherein:
the font data to be transmitted further comprises a character identifier associated with a character image.

19. The apparatus of claim 18, wherein:
the character identifier comprises either a single byte identifier including one data byte or a multiple byte identifier including two or more data bytes.

20. The computer program product of claim 10, wherein:
the character image comprises an ideographic character.
